(19) United States
(12) Patent Application Publication
(10) Pub. No.: US 2013/0252473 A1
(43) Pub. Date: Sep. 26, 2013

(54) GANGABLE POWER SUPPLY CHANNELS

(71) Applicants: John A. Dickey, Rockford, IL (US); Carl A. Wagner, Beloit, WI (US); Jeffrey T. Wavering, Rockford, IL (US); Michael Krenz, Roscoe, IL (US); Norbert J. Simper, Bissingen (DE); Kyle Steven Ives, Rockford, IL (US); Rainer J. Seidel, Tussenhausen (DE); Josef Maier, Munningen (DE)

(72) Inventors: John A. Dickey, Rockford, IL (US); Carl A. Wagner, Beloit, WI (US); Jeffrey T. Wavering, Rockford, IL (US); Michael Krenz, Roscoe, IL (US); Norbert J. Simper, Bissingen (DE); Kyle Steven Ives, Rockford, IL (US); Rainer J. Seidel, Tussenhausen (DE); Josef Maier, Munningen (DE)

(73) Assignee: HAMILTON SUNDSTRAND CORPORATION, Windsor Locks, CT (US)

(21) Appl. No.: 13/488,877

(22) Filed: Jun. 5, 2012

Related U.S. Application Data
(60) Provisional application No. 61/614,201, filed on Mar. 22, 2012.

(51) Int. Cl. H01R 31/06

(52) U.S. Cl. 439/651

(57) ABSTRACT

An interface module includes a first side having a plurality of input connectors of a same cross-sectional area corresponding to a same amperage rating, a second side having a plurality of output connectors of different cross-sectional areas from each other corresponding to different amperage ratings from each other, and wiring in the interface module configured to connect a first number of input connectors to a first one of the output connectors having a first amperage rating, and configured to connect a second number of input connectors to a second one of the output connectors having a second amperage rating different from the first amperage rating.

### BACKGROUND OF THE INVENTION

Solid state power controllers (SSPC) are currently available with either a fixed output rating or a rating which can be adjusted by either hardware or software. The SSPC's with fixed ratings have very little flexibility to accommodate different load distribution scenarios. The SSPC's with an adjustable output rating need to be designed for the highest possible rating. If an SSPC is programmed to operate at a rating lower than the highest rating the device wastes significant real estate, since a lot of power switching components are not operated at their rating level.

Additionally, SSPC's designed for a specific current rating do not always offer the best total solution for specific power distribution applications. Often it is desirable to have a single part number that can handle multiple different output currents, while at the same time minimizing the board space and components required.

### BRIEF DESCRIPTION OF THE INVENTION

Embodiments of the present disclosure include an interface module includes a first side having a plurality of input connectors of a same cross-sectional area corresponding to a same amperage rating, a second side having a plurality of output connectors of different cross-sectional areas from each other corresponding to different amperage ratings from each other, and wiring in the interface module configured to connect a first number of input connectors to a first one of the output connectors having a first amperage rating, and configured to connect a second number of input connectors to a second one of the output connectors having a second amperage rating different from the first amperage rating.

Embodiments of the present disclosure further include a power connection system, including a power module including a power output port having a plurality of first output connectors having a same cross-sectional size and a power interface module. The power interface module may include a first side having a plurality of first input connectors of a same cross-sectional size as the plurality of first output connectors of the power output port of the power module and configured to be connected with the plurality of first output connectors of the power output port and a second side including a plurality of second output connectors, a first one of the plurality of second output connectors connected to a first number of input connectors, and a second one of the plurality of second output connectors connected to a second number of input connectors different from the first number of input connectors.

Embodiments of the present disclosure further include a power supply system including a plurality of power supply modules, each having a same current rating and one or more parallel connection parts configured to connect two or more of the plurality of power supply modules to generate a power output corresponding to a combined current rating of the two or more of the plurality of power supply modules.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a power interface system according to an embodiment of the present disclosure;

FIG. 2 illustrates a power interface system according to another embodiment of the present disclosure;

FIGS. 3A and 3B illustrate a power interface module according to an embodiment of the disclosure;

FIG. 4 illustrates a power module port according to an embodiment of the present disclosure;

FIGS. 5A-5K illustrate power interface sub-modules according to embodiments of the present disclosure;

FIGS. 6A-6D illustrate cross-section views of power interface modules according to embodiments of the present disclosure;

FIG. 7 illustrates a power interface system according to an embodiment of the present disclosure;

FIGS. 8A-8C illustrates a power module according to an embodiment of the present disclosure; and

FIG. 9 illustrates a power interface module according to an embodiment of the present disclosure.

### DETAILED DESCRIPTION OF THE INVENTION

Embodiments of the present disclosure relate to providing power to various loads at various power levels.

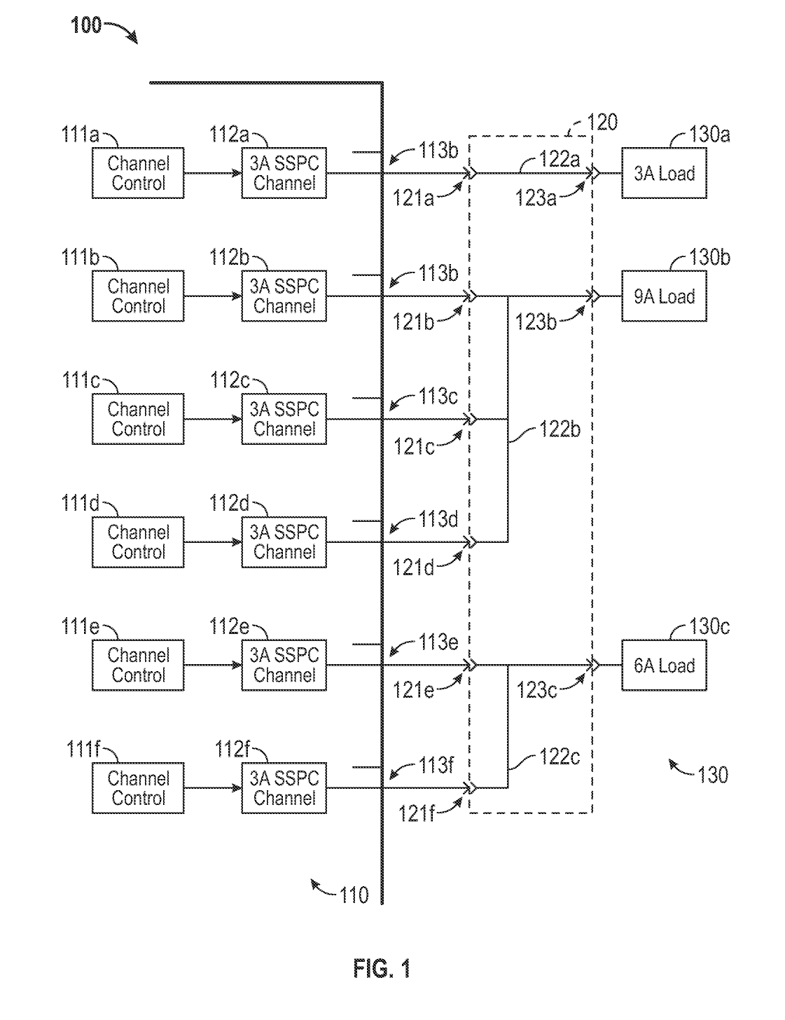

FIG. 1 illustrates a power interface system 100 according to an embodiment of the present disclosure. The power interface system 100 includes a power supply module 110, a power interface module 120, and a load 130. The power supply module includes a plurality of power supply channels, each providing power at the same amperage. For example, FIG. 1 illustrates six solid state power control (SSPC) channels 112a-112f, each providing up to 3A to a respective output connector 113a-113f. Channel control circuits 111a-111f control the power output via the SSPC channels 112a-112f. In one embodiment, the SSPC channels 112a-112f have the same circuit design and thermal resources.

While FIG. 1 illustrates six 3A SSPC channels, or six channels capable of providing any desired amperage up to the rated 3A, embodiments of the present disclosure encompass channels having any desired amperage, such as 1A, 2A, or 2.5A, and the power supply channels may correspond to any type of power supply.

The power interface module 120 includes input connectors 121a-121f corresponding to the output connectors 113a-113f of the power module, and configured to connect with the output connectors 113a-113f to transmit the electrical current from the output connectors 113a-113f of the power supply module 110 to the input connectors 121a-121f of the power interface module 120. The input connectors 121a-121f and output connectors 113a-113f may comprise conductive protrusions to be positioned within conductive receptacles, conductive pads, springs, wires, traces, or any other electrical terminals configured to conduct current from one device to another.

The power interface module 120 also includes output connectors 123a, 123b, and 123c configured to be connected to one or more loads 130a, 130b, and 130c. The power interface module 120 includes internal wiring 122a, 122b, and 122c to connect one output connector 123a, 123b, or 123c to one or more input connectors 121a-121f. Since each of the input connectors 121a-121f is configured to connect to a respective output connector 113a-113 carrying a same amperage, the connecting of multiple input connectors 121a-121f together results in output connectors 123a, 123b, and 123c configured to output current at different amperage levels.

For example, wiring 122a connects only one input connector 121a to only one output connector 123a, and as a result, the output connector 123a is connected only to one SSPC channel 112a and may output a current of up to only 3A to the load 130a. On the other hand, the wiring 122b connects all of the input connectors 121b-121d to a single output connector 123b, and as a result, the output connector 123b is connected to three SSPC channels 112b, 112c and 112d, and may output a current of up to 9A to the load 130b. The output connector 123c is similarly connected to multiple input connectors. The input connectors 121c and 121f connect to only one output connector 123c, and as a result, the output connector 123c is connected to two SSPC channels 112e and 112f, and may output a current of up to 6A to the load 130c.

Although three examples of wiring 122a, 122b, and 122c are provided in FIG. 1 to illustrate configurations of providing power from inputs configured to receive a same current level to outputs configured to receive different multiples of the current level of the inputs, embodiments of the present disclosure encompass any variation of connections of input connectors 121a-121f to provide an output of any desired current level from the power interface module 120. For example, in some embodiments, five, ten, or more connectors 121 may be connected to provide an output connector 123 of a desired output current level.

In embodiments of the present disclosure, one or more of the input connectors 121a-121f, wiring 122a-122c, and output connectors 123a-123c may have a size configured to correspond to a particular current rating. For example, in an embodiment in which an input connector 121, wiring 122, or output connector 123 is a wire or wiring, the size of the connector 121, wiring 122, and output connector 123 may be referred to as the gauge of the wire or wiring. In such an embodiment, the input connectors 121a-121f may all have the same gauge, or may be configured to receive the same gauge, wire. A gauge of the wiring 122 may decrease (and the diameter of the wiring 122 may increase) as the number of input connectors 121a-121f connected to the wiring 122 increases. Similarly, a gauge of the output connectors 123a-123c may decrease, and the diameter of the output connectors 123a-123c may increase, according to an increased number of input connectors 121a-121f connected to the output connectors 123a-123c.

In the embodiment illustrated in FIG. 1, the output connector 123b may have a smaller gauge, or a larger cross-sectional area, than the output connector 123a. Likewise, the output connector 123c may have a smaller gauge, or a larger cross-sectional area, than the output connector 123b. In some embodiments, the cross-sectional area of the output connector 123 is increased to correspond to an increased number of input connectors 121 connected to the output connector 123. In one embodiment, the increased cross-sectional area corresponds to an increased amperage rating, or an increase in the capacity of the output connectors 123 to transmit current. In the present specification, the reference numerals 121 and 123 refer to input connectors and output connectors generally, whereas the reference numerals 121a-121f refer to particular input connectors illustrated in FIG. 1, and the reference numerals 123a-123c refer to particular output connectors illustrated in FIG. 1.

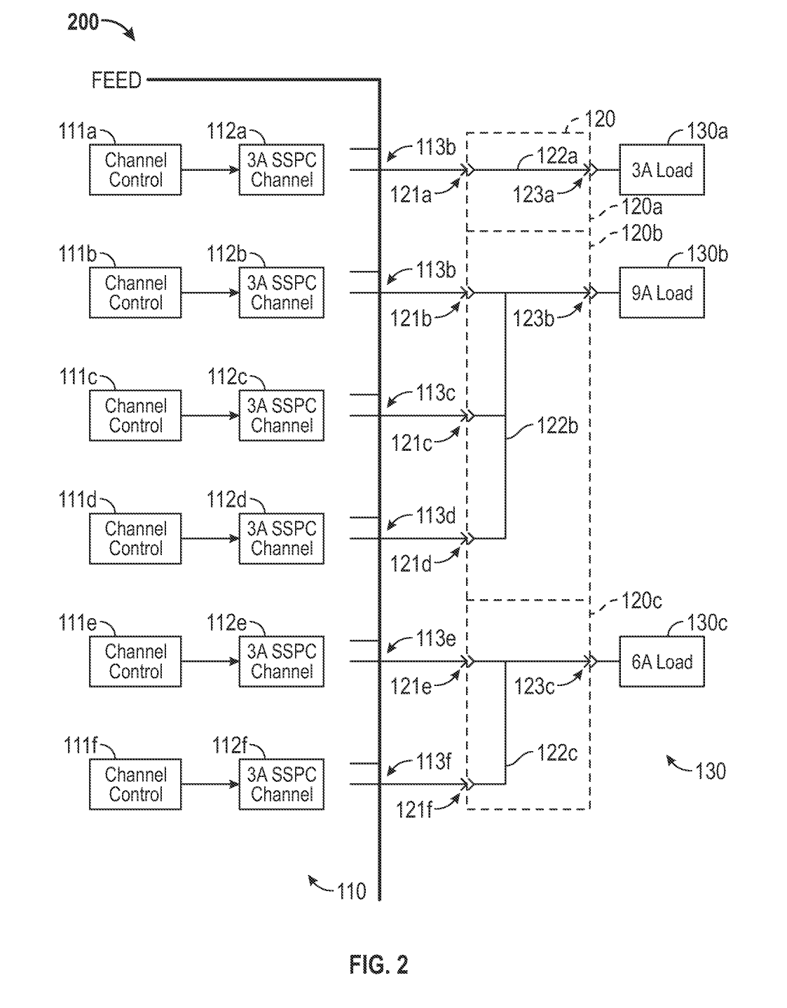

FIG. 2 illustrates a power interface system 200 according to another embodiment of the present disclosure. The power interface system 200 of FIG. 2 is similar to the power interface system 100 of FIG. 1. However, in the power interface system 200 of FIG. 2, the power interface module 120 is divided into a plurality of physically distinct sub-modules 120a, 120b, and 120c. In the present specification and claims, the terms physically distinct, or physically separate, refer to objects that have separate and defined outer borders or outer perimeter sides, such as blocks, that are not a part of other objects. For example, the sub-module 120a may comprise a block having predetermined dimensions around an outer diameter of the sub-module 120a. The sub-module 120a may be positioned adjacent to the sub-module 120b, but the sub-modules 120a does not physically combine with or merge with the sub-module 120b. Instead, sides of the sub-modules 120a and 120b may be located next to each other. Similarly, sub-module 120c may be positioned adjacent to sub-module 120b, but the sub-modules 120b and 120c remain physically distinct.

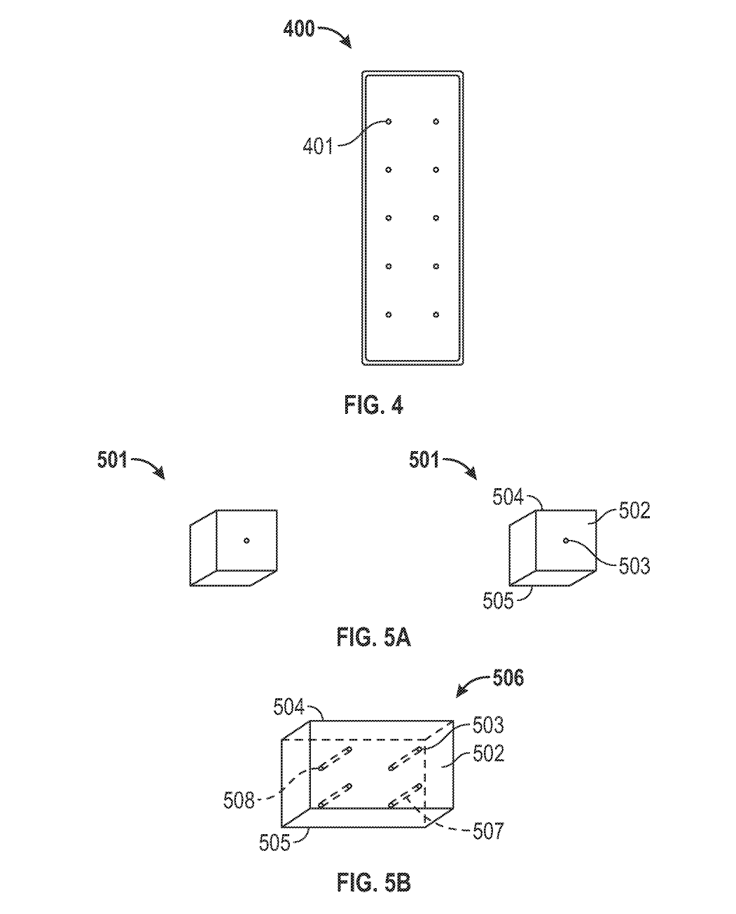

In one embodiment, the sub-modules 120a, 120b, and 120c are shaped so as to conform to a shape of an output port of the power supply module 110. FIG. 4 illustrates an example of an output port 400 of the power supply module 110. The output port 400 includes a plurality of output connectors 401. Each of the plurality of output connectors 401 may be of a same size and may be connected to an SSPC channel having the same current output level. The output connectors 401 of FIG. 4 may correspond to the output connectors 113 of FIGS. 1 and 2.

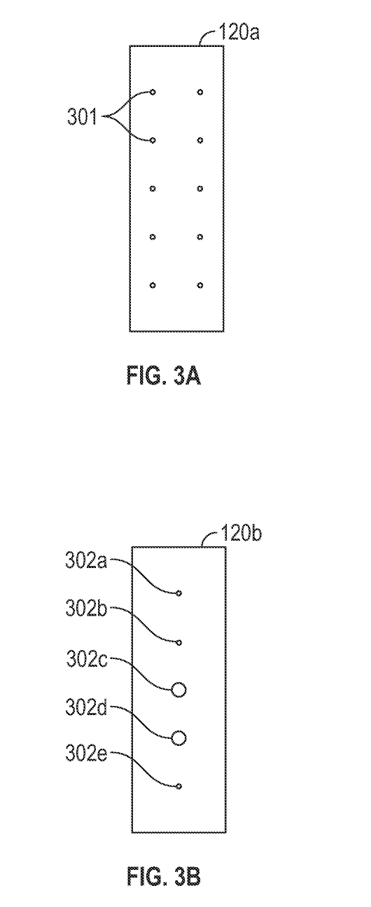

FIGS. 3A and 3B illustrate a power interface module 120 according to an embodiment of the disclosure. FIG. 3A illustrates an input side 120a of the power interface module 120. The input side 120a may include a plurality of input connectors 301. The input connectors 301 may have a same size or shape, and may have also have the same amperage rating, or a same capacity to transmit a current. The input connectors 301 may have shapes and sizes that complement the shapes and sizes of output connectors of a power supply module 110, such as the output connectors 113 of FIGS. 1 and 2 and the output connectors 401 of FIG. 4. In other words, in an embodiment in which the input connectors 301 are conductive protrusions, the output connectors of a power supply module may be conductive receptacles having a size and shape to receive the input connectors 301, to hold the input connectors 301 in place, and to make conductive contact with the input connectors 301.

FIG. 3B illustrates an output side 120b of the power interface module 120. The output side 120b may include a plurality of output connectors 302a-302e of varying shapes and sizes, which may correspond to different connections to input connectors 301 and varying amperage ratings. For example, each of the output connectors 302a and 302b of FIG. 3B may be connected to only one input connector 301, and so may be configured to transmit a current received by only one input connector 301. In addition, a cross-section area of the output connectors 302a and 302b may be substantially the same as the cross-sectional area of the input connectors 301. In addition, the amperage rating, or the current capacity of the output connectors 302a and 302b may be the same as the current capacity of one input connector 301. The output connectors 302a and 302b may have a size that is the same as the individual input connectors 301.

The output connectors 302c and 302d may each be connected to three input connectors 301. Accordingly, the output connectors 302c and 302d may each have a cross-sectional area larger than an input connector 301. The cross-sectional area may correspond to a current transmission capacity that is triple the current transmission capacity of only one input connector 301. In addition, the output connector 302e may be connected to two input connectors 301, and may have a cross-sectional area corresponding to a current transmission capacity that is twice that of one input connector 301. The output connector 302e may have a cross-sectional area larger than the cross-sectional area of the output connectors 302a and 302b, and smaller than the cross-sectional area of the output connectors 302c and 302d.

Although the output connectors 302a-302e of FIG. 3B all have a circular shape, embodiments of the present disclosure encompass connectors having any shape, including ovoid, planar, round, square, rectangular, polygonal, or any other shape. In addition, although output connectors 302a-302e having different amperage ratings have different sizes in FIG. 3B, in some embodiments, output connectors 302 may have a same size, even when configured to transmit different amperages. For example, an output connector 302 having a size corresponding to an amperage rating of 3A may be configured to transmit 1A, 2A, or 2.5A. In one embodiment in which an input connector 301 is connected to an SSPC channel configured to transmit X amperes, an output connector 302 of a first cross-sectional area may be configured to transmit X amperes, 2X amperes, and 3X amperes, an output connector 302 of a second cross-sectional area may be configured to transmit 4X amperes, 5X amperes, and 6X amperes, an output connector 302 of a third cross-sectional area may be configured to transmit 7X, 8X, and 9X amperes, etc.

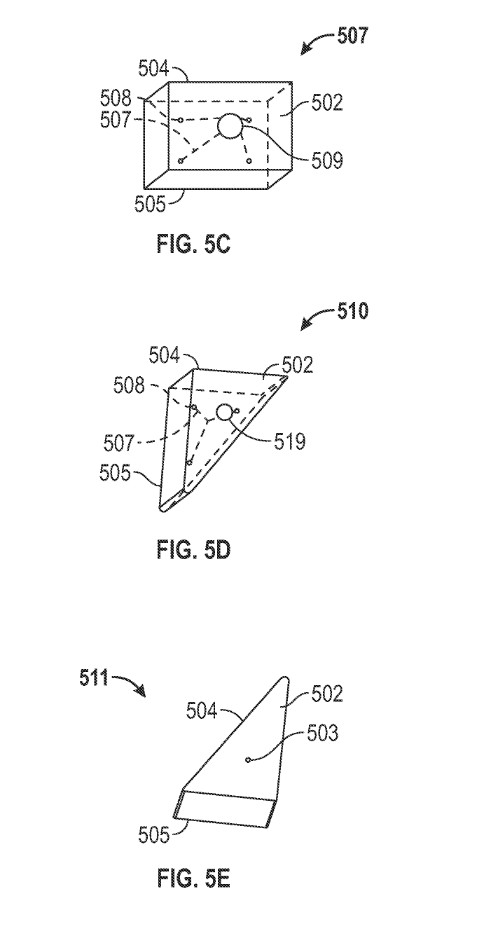

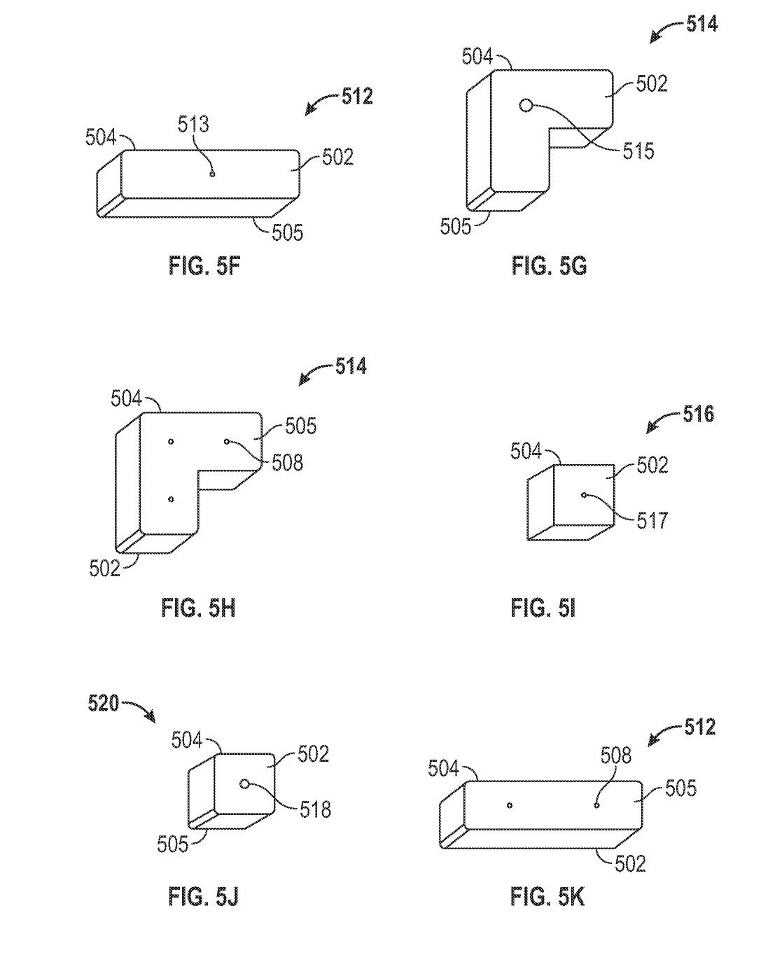

FIGS. 5A-5K illustrate power interface sub-modules according to embodiments of the present disclosure. In some embodiments of the present disclosure, such as the embodiment described in FIG. 2, the power interface module 120 may comprise multiple separate sub-modules of varying shapes and sizes. FIGS. 5A-5K illustrate only a few examples of sub-modules for purposes of description. However, embodiments of the present disclosure encompass any combinations of sub-modules having a same input connector and output connectors configured to transmit different amperage levels, where the combinations of sub-modules are configured to be mounted together to an output port of a power supply module 110, such as the output port 400 of FIG. 4.

FIG. 5A illustrates a pair of sub-modules 501 configured to connect one input connector to one output connector 503. The sub-module 501 includes an output-side surface 502 including the output connector 503, an input-side surface 505, and an outer perimeter 504. The sub-modules 501 are configured such that when the input-side surface 505 is mounted to an output port of a power supply module, the outer perimeter 504 may contact an adjacent sub-module that is also connected to the output port of the power supply module.

FIG. 5B illustrates a sub-module 506 configured to connect four input connectors 508 to four respective output connectors 503. Wiring 507, represented as dashed lines, connects the four input connectors 508, respectively, to the four output connectors 503. The sub-module 506 includes an output-side surface 502 including the output connectors 503, an input-side surface 505, and an outer perimeter 504. The sub-module 506 is configured such that when the input-side surface 505 is mounted to an output port of a power supply module, the outer perimeter 504 may contact an adjacent sub-module that is also connected to the output port of the power supply module.

FIG. 5C illustrates a sub-module 507 configured to connect four input connectors 508 to one output connector 509. Wiring 507, represented as dashed lines, connects the four input connectors 508 to the one output connector 509. The sub-module 507 includes an output-side surface 502 including the output connector 509, an input-side surface 505, and an outer perimeter 504. The sub-module 507 is configured such that when the input-side surface 505 is mounted to an output port of a power supply module, the outer perimeter 504 may contact an adjacent sub-module that is also connected to the output port of the power supply module. In the embodiments of FIGS. 5A-5C, the sub-modules 501, 506, and 507 have substantially square shapes. However, embodiments of the present disclosure encompass any desired shape of sub-modules.

FIG. 5D illustrates a sub-module 510 configured to connect three input connectors 508 to one output connector 519. Wiring 507, represented as dashed lines, connects the three input connectors 508 to the one output connector 519. The sub-module 510 includes an output-side surface 502 including the output connector 519, an input-side surface 505, and an outer perimeter 504. The sub-module 510 is configured such that when the input-side surface 505 is mounted to an output port of a power supply module, the outer perimeter 504 may contact an adjacent sub-module that is also connected to the output port of the power supply module.

FIG. 5E illustrates a sub-module 511 configured to connect one input connector to one output connector 503. The sub-module 511 includes an output-side surface 502 including the output connector 503, an input-side surface 505, and an outer perimeter 504. The sub-module 511 is configured such that when the input-side surface 505 is mounted to an output port of a power supply module, the outer perimeter 504 may contact an adjacent sub-module that is also connected to the output port of the power supply module. For example, the sub-module 511 may be configured such that a hypotenuse of the outer perimeter 504 contacts the hypotenuse of the outer perimeter 504 of the sub-module 510 of FIG. 5D when the sub-modules 511 and 510 are connected next to each other in an output port of a power supply module.

FIG. 5F illustrates a sub-module 512 configured to connect two input connectors to one output connector 513. The sub-module 512 includes an output-side surface 502 including the output connector 513, an input-side surface 505, and an outer perimeter 504. The sub-module 512 is configured such that when the input-side surface 505 is mounted to an output port of a power supply module, the outer perimeter 504 may contact an adjacent sub-module that is also connected to the output port of the power supply module.

FIG. 5K illustrates the input-side surface 505 of the sub-module 512 according to one embodiment. The input-side surface 505 may include two input connectors 508 to connect to two output connectors of a power supply module, and wiring inside the sub-module 512 may connect the two input connectors 508 to the one output connector 513.

FIG. 5G illustrates a sub-module 514 configured to connect three input connectors to one output connector 515. The sub-module 514 includes an output-side surface 502 including the output connector 515, an input-side surface 505, and an outer perimeter 504. The sub-module 514 is configured such that when the input-side surface 505 is mounted to an output port of a power supply module, the outer perimeter 504 may contact an adjacent sub-module that is also connected to the output port of the power supply module.

FIG. 5H illustrates the input-side surface 505 of the sub-module 514 according to one embodiment. The input-side surface 505 may include three input connectors 508 to connect to three output connectors of a power supply module, and wiring inside the module 514 may connect the three input connectors 508 to the one output connector 515.

FIG. 5I illustrates a sub-module 516 configured to connect one input connector to one output connector 517. Unlike the sub-modules 501 of FIG. 5A, the sub-module 516 may be mounted to a plurality of output connectors of a power supply port, but may transmit current from only one of the output connectors of the power supply port. The sub-module 516 includes an output-side surface 502 including the output connector 517, an input-side surface 505, and an outer perimeter 504. The sub-module 516 is configured such that when the input-side surface 505 is mounted to an output port of a power supply module, the outer perimeter 504 may contact an adjacent sub-module that is also connected to the output port of the power supply module. The sub-module 516 may be further configured to be mounted to four output connectors of an output port of a power supply module. However, in the embodiment described in FIG. 5I, three dummy connectors may be connected to output connectors of the output port of the power supply module, and only one input connector may be connected to the output connector 517 via a wire internal to the sub-module 516.

FIG. 5J illustrates a sub-module 520 configured to connect three input connectors to one output connector 518. The sub-module 520 includes an output-side surface 502 including the output connector 518, an input-side surface 505, and an outer perimeter 504. The sub-module 520 is configured such that when the input-side surface 505 is mounted to an output port of a power supply module, the outer perimeter 504 may contact an adjacent sub-module that is also connected to the output port of the power supply module. The sub-module 520 may be configured to be mounted to four output connectors of an output port of a power supply module. However, in the embodiment described in FIG. 5I, one dummy connector may connect to one output connector of the output port of the power supply module, and only three input connectors may be connected to the output connector 518 via a wire internal to the sub-module 520. In other words, in the embodiments illustrated in FIGS. 5I and 5J (as well as FIGS. 5B and 5C), sub-modules having a same outer perimeter shape may be configured to connect to a same number of output connectors of a power supply module, but may each have different output connector configurations, including different numbers of output connectors and output connectors having different cross-sectional areas.

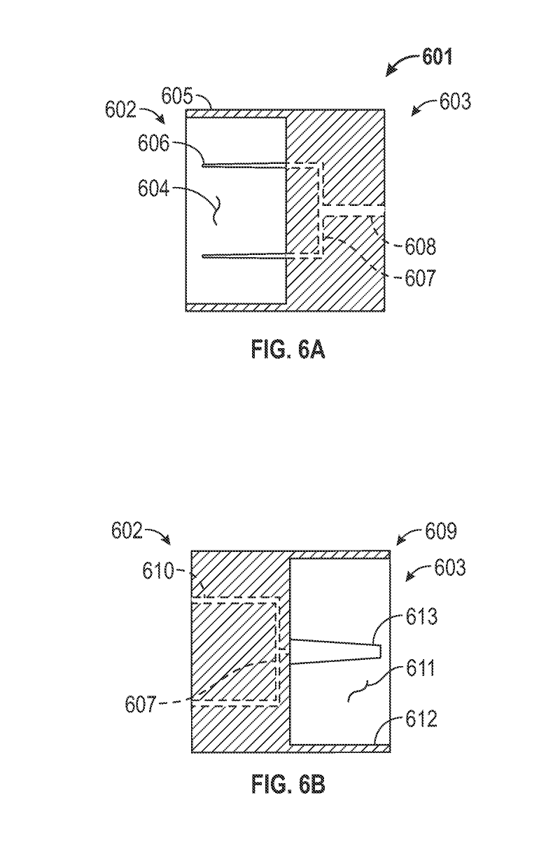

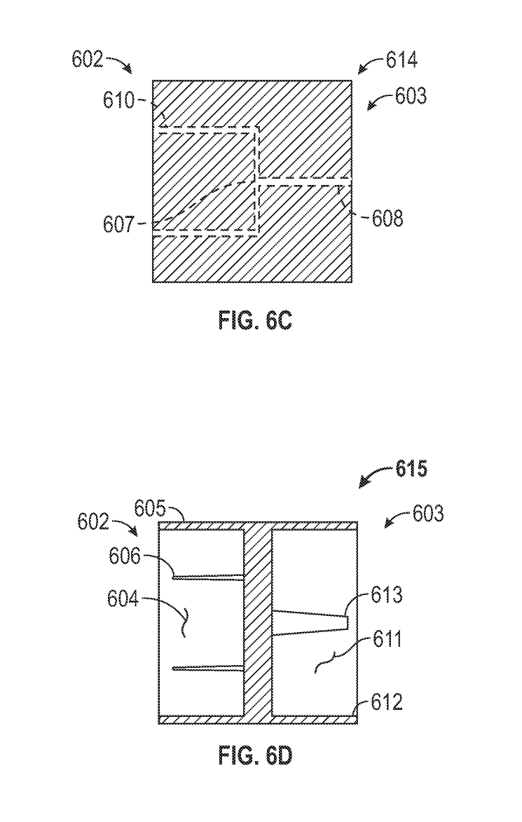

FIGS. 6A-6D illustrate cross-section views of power interface modules according to embodiments of the present disclosure. In embodiments of the present disclosure, input connectors of power interface modules interact with output connectors of power supply modules to transmit current from the output connectors of the power supply modules to the input connectors of the power interface modules. In addition, output connectors of power interface modules may connect to input connectors of load connectors, such as cables, circuit boards, input ports of load devices or load systems, or other any other input connectors configured to connect to the output connectors of the power interface module to transmit power from the output connectors of the power interface module to a load. Input connectors and output connectors may include pins, wires, pads, springs, receptacles, conductive traces, or any other conductive protruding part, conductive receiving part, conductive interlocking part, or conductive connection part. FIGS. 6A-6D illustrate only a few examples of configurations of input connectors and output connectors.

FIG. 6A illustrates a cross-section view of a power interface module 601 according to one embodiment. The power interface module 601 includes an input side 602 and an output side 603. The input side 602 includes an input port 604 defined by a wall 605 and input connectors 606. The input connectors 606 are conductive protruding parts, such as pins. The output side 603 includes an output connector 608, which may be a conductive recess, such as a recess having a wall or lining formed of copper, conductive springs, or any other conductive material. Wiring 607 connects the input connectors 606 to the output connector 608.

FIG. 6B illustrates a cross-section view of a power interface module 609 according to one embodiment. The power interface module 609 includes an input side 602 and an output side 603. The input side 602 includes input connectors 610. The input connectors may be conductive recesses, such as a recess having a wall or lining formed of copper, conductive springs, or any other conductive material. The output side 603 includes an output port 611 defined by a wall 612 and an output connector 613. The output connector 613 is a conductive protruding part, such as a pin. Wiring 607 connects the input connectors 610 to the output connector 613.

FIG. 6C illustrates a cross-section view of a power interface module 614 according to one embodiment. The power interface module 614 includes an input side 602 and an output side 603. The input side 602 includes input connectors 610. The input connectors may be conductive recesses, such as a recess having a wall or lining formed of copper, conductive springs, or any other conductive material. The output side 603 includes an output connector 608, which may be a conductive recess, such as a recess having a wall or lining formed of copper, conductive springs, or any other conductive material. Wiring 607 connects the input connectors 606 to the output connector 608.

FIG. 6D illustrates a cross-section view of a power interface module 615 according to one embodiment. The power interface module 615 includes an input side 602 and an output side 603. The input side 602 includes an input port 604 defined by a wall 605 and input connectors 606. The input connectors 606 are conductive protruding parts, such as pins. The output side 603 includes an output port 611 defined by a wall 612 and an output connector 613. The output connector 613 is a conductive protruding part, such as a pin. Wiring 607 connects the input connectors 610 to the output connector 613.

FIGS. 6A-6D are provided to illustrate examples of configurations of input connectors and output connectors. However, embodiments of the present disclosure encompass input connectors and output connectors of varying sizes and shapes, and are not limited to those illustrated in FIGS. 6A-6D. For example, in one embodiment, the walls 605 and 612 may be omitted, the power interface modules 601, 609, 614, and 615 may have shapes other than rectangular cross-sectional shapes, the input connectors 606 or 610 may have shapes other than a pin shape and a receptacle to receive a pin, or the output connectors 608 and 613 may have shapes other than a pin shape and a receptacle to receive a pin.

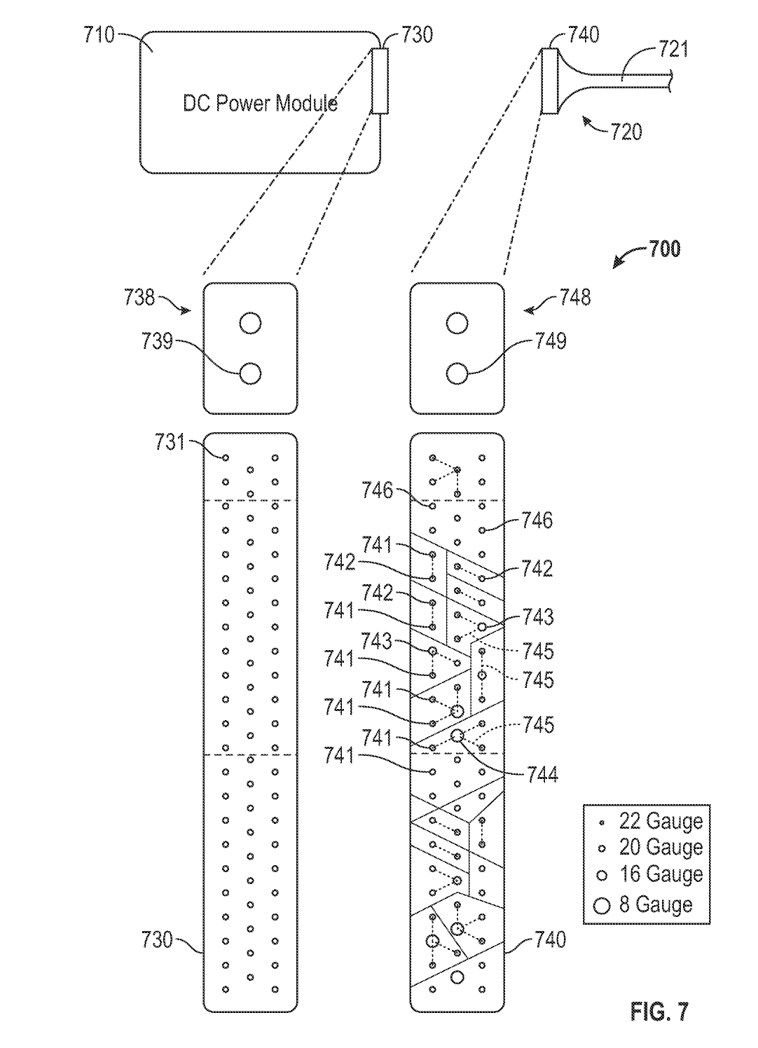

FIG. 7 illustrates a power interface system 700 according to an embodiment of the present disclosure. The power interface system 700 includes a power supply module 710 having an output port 730, and an electrical transmission medium 720, such as a wire or cable 721 connected to a power interface module 740.

The output port 730 may have a plurality of first output connectors 731, each having a same size or cross-sectional area corresponding to a same current transmission capacity. The output port 730 may also include one or more high-current connection portions 738 including one or more second output connectors 739 having a larger size or cross-sectional area than the first connectors 731. For example, in one embodiment, a system may be configured to transmit power at 25A via the second output connectors 739 and at 2.5A via the first output connectors 731. Although one high-current connection portion 738 is illustrated in FIG. 7, any number of different current transmission capacity portions may be provided according to design specifications of a system.

The power interface module 740 may have a plurality of first input connectors 741 configured to be connected to the first output connectors 731 of the output port 730. The power interface module 740 may also include a high-current connection portion 748 including one or more second input connectors 749 to connect to the second output connectors 739 of the output port 730.

The first input connectors 741 may be connected to varying numbers of other first input connectors 741 and to one output connector to form third output connectors 746, fourth output connectors 742, fifth output connectors 743, and sixth output connectors 744 having different cross-sectional areas corresponding to numbers of connected first input connectors 741. For example, each third output connector 746 may be connected to only one first input connector 741, and may have a cross-sectional area corresponding to the current transmission capacity of only one first input connector 741 and only one first output connector 731 of the output port 730. Each fourth output connector 742 may be connected to two first input connectors 741 and may have a cross-sectional area corresponding to twice the current transmission capacity of one input connector 741. Wiring 745, represented as dashed lines, connects the first input connectors 741 to the third, fourth, fifth, and sixth output connectors 746, 742, 743, and 744.

Each fifth output connector 743 may be connected to three first input connectors 741, and may have a cross-sectional area corresponding to a current transmission capacity that is three times the current transmission capacity of one first input connector 741. Similarly, each sixth output connector 744 may be connected to four first input connectors 741, and may a cross-sectional area corresponding to a current transmission capacity that is four times the current transmission capacity of one first input connector 741.

The output connectors 746, 742, 743, and 744 may be connected to wires bound within the cable 721, or to wires that are not bound within a same cable 721. The wires may have cross-sectional areas corresponding to current transmission capacities of the output connectors 746, 742, 743, and 744. For example, the output connectors 746 may have a 22 gauge cross-section area, the output connectors 742 may have a 20 gauge cross-section area, the output connectors 743 may have a 16 gauge cross-section area, and the output connectors 744 may have an 8 gauge cross-section area.

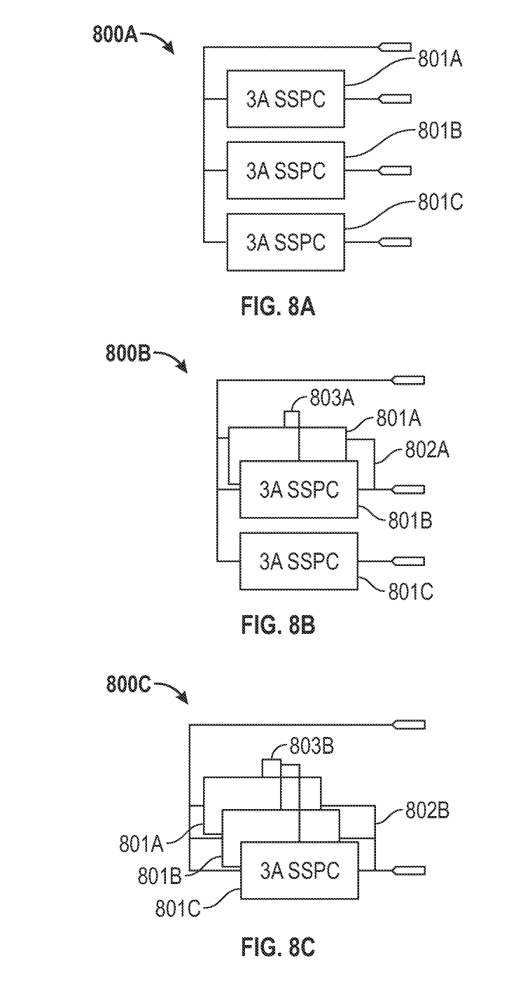

FIGS. 8A to 8C illustrate power supply modules 800a, 800b, and 800c according to embodiments of the present disclosure. Each power supply module 800a, 800b, and 800c includes a plurality of power supply channels 801a, 801b, and 801c. In FIGS. 8A-8C the power supply channels 801a-801c are 3 amp SSPC channels. Each SSPC channel is controlled by a separate microcontroller, which may control the SSPC channel by receiving instructions via a data bus or by executing commands stored in memory, such as dedicated microcontroller memory.

In embodiments of the present disclosure, the plurality of separate power supply channels 801a-801c each provide a predetermined current transmission capacity, and the current transmission capacity of each of the power supply channels 801a-801c may be the same. The separate power supply channels 801a-801c may be connected in parallel to provide outputs having different and configurable current transmission capacities.

For example, FIG. 8A illustrates three separate power supply channels 801a-801c, each providing an output current of 3A. Three separate loads or load systems may be connected to the respective power supply channels 801a-801c. FIG. 2 illustrates an embodiment in which two power supply channels 801a and 801b are connected in parallel, providing an output current level of 6A, and the power supply channel 801c is separate, providing an output current level of 3A. The power supply channels 801a and 801b may be connected in parallel by connecting the outputs together with a first parallel connection part 802a, which may include a power interface module, such as the power interface module 120 illustrated in FIGS. 1 and 2, switches on a circuit board, or any other parallel connection mechanism. The power supply channels 801a and 801b may further be connected by a second parallel connection part 803a, which may include one or more of a power connection and a data connection. For example, a data connection line may coordinate the microcontrollers of the two separate power supply channels 801a and 801b to supply current at a consistent rate and at a same time.

Similarly, FIG. 8C illustrates an embodiment in which three power supply channels 801a, 801b and 801c are connected in parallel, providing an output current level of 9A. The power supply channels 801a-801c may be connected in parallel by connecting the outputs together with a third parallel connection part 802b, which may include a power interface module, such as the power interface module 120 illustrated in FIGS. 1 and 2, switches on a circuit board, or any other parallel connection mechanism. The power supply channels 801a-801c may further be connected by a fourth parallel connection part 803b, which may include one or more of a power connection and a data connection. For example, a data connection line may coordinate the microcontrollers of the two separate power supply channels 801a-801c to supply current at a consistent rate and at a same time

According the embodiment illustrated in FIGS. 8A-8C, a solid state power controller (SSPC) may be configured to have a plurality of low current SSPC channels that can be connected in parallel to form higher current channels. The low current SSPC channels may be combined or output separately to provide current outputs of varying levels, allowing for the use of the full number of switches on a given solid state power controller board.

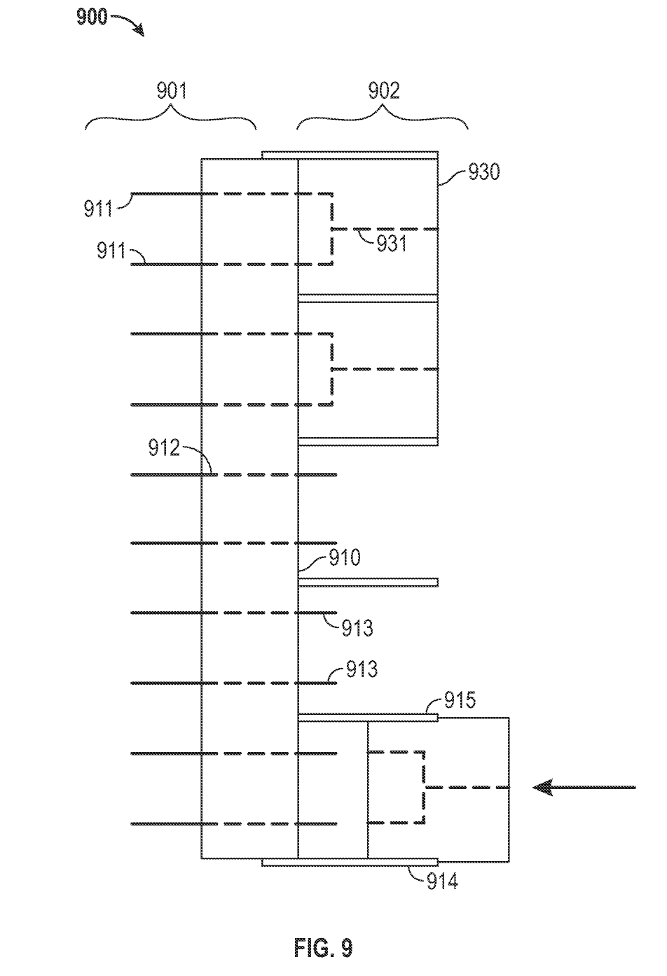

FIG. 9 illustrates a power interface module 900 according to an embodiment of the present disclosure. The power interface module 900 may correspond to the power interface module 120 of FIG. 2. The power interface module 900 includes a board side 901 and a load side 902. In one embodiment, the power interface module 900 is configured to connect a power supply system of an aircraft with electrical systems in the aircraft. In such a case, the board side 901 is connected to power supply board, and the load side 902 is connected to circuits within an electrical system of an aircraft.

The power interface module 900 includes an insulating substrate 910, pins 911 on the board side 901 to connect to a power supply, wiring within the insulating substrate 910, and pins 912 on the load side 902. Although FIG. 9 illustrates pins 911 and 913 extending from the substrate 910, embodiments of the present disclosure also include holes to receive pins, or in other words, the pins 911 and 913 may be replaced with conductive holes in the substrate 910 to receive conductive pins, as illustrated for example, in FIGS. 6A-6D.

The power interface module 900 is configured to receive multiple sub-modules 930 by electrically connecting wiring 931 in the sub-modules 930 with the pins 913 and wiring 921 of the substrate 910. One or more outer walls 914 and inner dividers 915 may form a casing to receive the sub-modules 930 and to lock the sub-modules 930 into place.

The sub-modules 930 may correspond to the sub-modules 507, 511, 512, 514, 516, and 520 of FIGS. 5A-5K. In one embodiment, each of the sub-modules 930 has the same dimensions, such as height, width, and depth, while having different internal electrical connections. For example, one sub-module 930 may have a cube-shape similar to the sub-module 506 of FIG. 5B, and may connect four electrical connectors from the substrate 910 with four corresponding electrical connectors of the sub-module 930. Another sub-module 930 may have the same outer dimensions, such as the cube-shaped module of FIG. 5C, but may have different electrical connections, such as connecting four electrical connectors from the substrate 910 with one electrical connector of the sub-module 930.

Accordingly, in some embodiments, a variety of different power interface modules 900 may be manufactured to using the same frame, such as the substrate 910 and a pre-manufactured variety of sub-modules 930 having different internal electrical connections to provide output power at different levels. Each sub-module 930 may be inserted into the frame, as indicated by the arrow of FIG. 9 and locked into place by walls 914 and/or dividers 915.

As described above, embodiments of the present disclosure encompass systems and methods that allow for matching the circuit components of one or more SSPC's with a particular load while still supporting variable sized amperage settings. A number of circuit components, such as power switches and circuitry for current and thermal handling capability may be configured to correspond to programmable loads. The programming of the loads may allow for such matching without requiring design modifications or changes to the SSPC board and may allow for each channel on each board in the system to be individually programmed to allow for any combination of channels and amperage ratings up to the point of 100% utilization of the available circuits on the board. The SSPC channels may have matching circuit designs and thermal resources and any combination of SSPC channels may be grouped together.

Embodiments of the present disclosure encompass a connector, such as the power interface module, having interchangeable contact inserts that group 2, 3, 4, 5, etc. adjacent channel pins together to form larger SSPC's. In one embodiment, the connections to the board are an array of all the same size pins, each rated for the current handling of one of the small channels. The connections to the wiring may be sized to match the wire.

As one of skill in the art will realize, the embodiments of the present disclosure may allow one power supply board layout to be used for many different combinations of load ratings by simply reconfiguring the selectable combinations of connector inserts instead of designing multiple sizes of SSPC's. While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An interface module, comprising:
a first side having a plurality of input connectors of a same cross-sectional area corresponding to a same amperage rating;
a second side having a plurality of output connectors of different cross-sectional areas from each other corresponding to different amperage ratings from each other; and
wiring in the interface module configured to connect a first number of input connectors to a first one of the output connectors having a first amperage rating, and configured to connect a second number of input connectors to a second one of the output connectors having a second amperage rating different from the first amperage rating.

2. The interface module of claim 1,
wherein the first number of input connectors is greater than the second number of input connectors, and
wherein the first one of the output connectors has a cross-sectional diameter greater than the second one of the output connectors.

3. The interface module of claim 1, wherein each output connector having a cross-sectional size larger than another output connector of the plurality of output connectors is connected by the wiring to more input connectors than the another output connector.

4. The interface module of claim 1, wherein the interface module is made up of a plurality of physically distinct interface sub-modules, each interface sub-module comprising the first side having the plurality of input connectors having the same cross-sectional size as each other interface sub-module and the second side having the plurality of output connectors having different cross-sectional sizes than output connectors of at least one other interface sub-module.

5. The interface module of claim 4, wherein the plurality of interface sub-modules are shaped so as to be positioned adjacent to each other such that the input connectors of adjacently-positioned interface sub-modules correspond to a position of output power connectors of a power module.

6. The interface module of claim 4, wherein the plurality of interface sub-modules is shaped so as to be positioned adjacent to each other such that a spacing between adjacent input connectors of adjacent interface sub-modules is equal.

7. The interface module of claim 4, wherein each of the plurality of interface sub-modules has a same shape around an outer perimeter.

8. The interface module of claim 4, wherein at least one interface sub-module having an output connector of a different cross-sectional size than another interface sub-module has a different shape around a perimeter than the another interface sub-module.

9. The interface module of claim 8, wherein each of the interface sub-modules having output connectors of different cross-sectional sizes than another interface sub-module has a different shape around the perimeter than the another interface sub-module.

10. The interface module of claim 1, wherein the plurality of output connectors includes at least a first output connector connected by the wiring to only one input connector, a second output connector larger than the first output connector connected by the wiring to only two input connectors, and a third output connector larger than the second output connector connected by the wiring to at least three input connectors.

11. A power connection system, comprising:
a power module including a power output port having a plurality of first output connectors having a same cross-sectional size; and
a power interface module, comprising:
a first side having a plurality of first input connectors of a same cross-sectional size as the plurality of first output connectors of the power output port of the power module and configured to be connected with the plurality of first output connectors of the power output port; and
a second side including a plurality of second output connectors, a first one of the plurality of second output connectors connected to a first number of input connectors, and a second one of the plurality of second output connectors connected to a second number of input connectors different from the first number of input connectors.

12. The power connection system of claim 11, further comprising a cable having a plurality of wires connected to the plurality of second output connectors, the cable including a plurality of wires having different amperage ratings, wherein a first wire having a first amperage rating is connected to the first one of the plurality of second output connectors, and a second wire having a second amperage rating is connected to the second one of the plurality of second output connectors.

13. The power connection system of claim 11, wherein the power interface module includes a plurality of physically distinct sub-modules, the first one of the plurality of second output connectors located on a first sub-module of the plurality of sub-modules, and the second one of the plurality of second output connectors located on a second sub-module of the plurality of sub-modules.

14. The power connection system of claim 13, wherein the first and second sub-modules have different outer-diameter shapes.

15. The power connection system of claim 14, wherein the first and second sub-modules have outer-diameter shapes, such that the first and second sub-modules are positionable to be simultaneously adjacent to each and connected to the power output port of the power module.

16. The power connection system of claim 11, wherein the first input connectors are one of pins and conductive receptacles configured to receive the pins, and the first output connectors are the other one of pins and conductive receptacles configured to receive the pins.

17. The power connection system of claim 11, wherein the first number of input connectors is less than the second number of input connectors, and
wherein the first one of the plurality of second output connectors has a cross-sectional diameter smaller than the second one of the plurality of second output connectors.

18. The power connection system of claim 17, wherein the cross-sectional diameter of the second one of the plurality of second output connectors corresponds to an amperage rating greater than the cross-sectional diameter of the first one of the plurality of second output connectors.

19. A power supply system, comprising:
a plurality of power supply modules, each having a same current rating; and
one or more parallel connection parts configured to connect two or more of the plurality of power supply modules to generate a power output corresponding to a combined current rating of the two or more of the plurality of power supply modules.

20. The power supply system of claim 19, wherein the one or more parallel connection parts includes a first parallel connection part to connect a first number of power supply modules in parallel and a second parallel connection part configured to connect a second number of power supply modules in parallel, and
wherein the first and second parallel connection parts are interchangeably connectable to an output port of a power supply device including the plurality of power supply modules.
